(19) United States
(12) Patent Application Publication
(10) Pub. No.: US 2015/0001013 A1
(43) Pub. Date: Jan. 1, 2015

(54) BRAKE PAD ASSEMBLY

(71) Applicant: Trevor Michael Mennie, Mayfield (GB)

(72) Inventor: Trevor Michael Mennie, Mayfield (GB)

(21) Appl. No.: 14/363,706

(22) PCT Filed: Dec. 6, 2012
(86) PCT No.: PCT/IB2012/057040

§ 371 Date: Jun. 6, 2014

(30) Foreign Application Priority Data
Dec. 6, 2011 (GB) 1120957.4
Mar. 2, 2012 (GB) PCT/GB2012/050473
Mar. 16, 2012 (GB) 1204669.4
Sep. 27, 2012 (GB) 1217286.2

(51) Int. Cl. F16D 65/00; F16D 65/092

(52) U.S. Cl. CPC F16D 65/0031; F16D 65/092
USPC 188/73.1; 188/250 B

(57) ABSTRACT

A brake pad assembly includes a brake pad having a braking surface. A peripheral wall is provided about the periphery of the braking surface of the brake pad. A perimeter void is provided between the peripheral wall and at least a portion of the brake pad. The perimeter void is in fluid communication with the braking surface of the brake pad. A first set of one or more openings are provide in fluid communication with the perimeter void for removing brake dust from the braking surface of the brake pad.

This application is entitled to the benefit of, and incorporates by reference essential subject matter disclosed in PCT Application No. PCT/IB2012/057040 filed on Dec. 6, 2012, which claims priority to Great Britain Application No. 1120957.4 filed Dec. 6, 2011, PCT Application No. PCT/GB2012/050473 filed Mar. 2, 2012, Great Britain Application No. 1204669.4 filed Mar. 16, 2012 and Great Britain Application No. 1217286.2 filed Sep. 27, 2012.

### BACKGROUND OF THE INVENTION

1. Technical Field

The present invention relates to a brake pad assembly, a brake system, a method of using a brake pad assembly or brake system, and a control system for a brake system. The present invention also relates to a kit and method for modifying a brake pad or brake system. Preferred embodiments of the present invention are directed to brake pads, brake pad assemblies or brake systems for vehicles.

2. Background Information

Brake systems for vehicles typically comprise a brake rotor fixed to the wheel of the vehicle. The brake rotor (which may be a disc or drum) rotates with the wheel when the vehicle is moving. With disc brakes, a pair of brake pads is typically positioned with the respective brake pads on either side of the brake rotor, and the brake pads are typically brought into firm contact with the brake rotor by brake calipers. With drum brakes, brake pads are typically positioned on the inside of the brake drum and are forced outwards into firm contact with the brake drum.

Brake pads are typically fixed to a static part of the vehicle, and do not rotate with the wheel when the vehicle is moving. When the brake is activated, the brake pad is pressed firmly against the brake rotor, and friction between the static brake pad and rotating rotor causes the speed of rotation of the rotor, and therefore the speed of rotation of the wheel, to slow. This in turn slows the vehicle.

When the brake is not being activated, brake pads are usually positioned in close proximity to the brake rotor so that the distance that the brake pad needs to travel in order to firmly contact the brake rotor is small and so that the activation time for the brake is short. This is particularly the case with hydraulically actuated brakes, in which a piston that is provided at the brake pedal of the vehicle to actuate the brake is in hydraulic communication with a piston that is provided at the brake pad to move the pad into contact with the rotor. The brake pedal piston has a smaller diameter than the brake pad piston, such that a larger movement/lower force provided at the brake pedal to activate the brake is converted into a much smaller movement but a much larger force at the brake pad to move the pad. Thus, with hydraulically actuated brakes, the distance between the brake pad and brake rotor is typically necessarily small so that an appropriate amount of force can be applied by the brake pad.

A small distance between a brake pad and brake rotor can also reduce the amount of debris that can accumulate between the brake pad and brake rotor, and can keep the brake pad dry by reducing the amount of water ingress.

In some arrangements, brake pads may even be positioned in light contact with the brake rotor even when the brake is not being activated so as to minimize the distance and time to activate the brake.

However, a problem with these arrangements exists in that intermittent or constant contact between the brake pad and brake rotor when the brake is not being activated generates an undesired braking force that the vehicle has to overcome. This reduces the power and efficiency of the vehicle, and leads to higher fuel consumption. The intermittent or constant contact between the pads and rotor also causes wear on the brake pads and rotors, which can shorten the lifetime of the brake pads and rotors and can produce polluting brake pad dust.

### SUMMARY OF THE INVENTION

The present invention seeks to provide brake systems that address the aforementioned problems.

According to an aspect of the present invention there is provided a brake system comprising: a brake pad having a braking surface; and a pressurized fluid supply in fluid communication with the braking surface of the brake pad; wherein the system is configured such that fluid from the pressurized fluid supply is provided to the braking surface of the brake pad under non-braking conditions.

Advantageously, by providing fluid from a pressurized fluid supply to the braking surface of the brake pad, the brake pad may be forced away from the surface of any adjacent brake rotor under non-braking conditions. The fluid may also act as a lubricant between the brake pad and any adjacent rotor under non-braking conditions. This can remove or reduce the amount of frictional contact between the pads and the rotor under non-braking conditions, which in turn can increase the power and efficiency of the vehicle, and lead to lower fuel consumption. The reduced amount of frictional contact can also decrease the amount of brake pad and brake rotor wear, leading to reduced maintenance costs for replacement brake pads.

The present invention is further advantageous in that the fluid supply may cool the braking surface of the brake pad. This may reduce the incidence of brake fade, which occurs when brake pads become too hot. The fluid may also remove debris and/or water from the braking surfaces of the brake pad and rotor.

The present invention is further advantageous in that any noise generated by contact between the brake pad and an adjacent brake rotor may be reduced or avoided.

The present invention may also provide a substantially fail-safe system, in that any failure in the pressurized fluid supply may result in a brake system that operates in a substantially conventional manner.

The brake system preferably comprises a disc brake. In these embodiments, the brake system preferably comprises a pair of opposed brake pads, preferably joined by calipers. However, in other embodiments the brake system may comprise a single brake pad and/or may comprise a drum brake.

The brake system preferably comprises a brake rotor positioned adjacent to the braking surface of the brake pad. The fluid from the pressurized fluid supply preferably provides a gap between the brake rotor and the braking surface of the brake pad when provided to the braking surface under non-braking conditions.

As will be appreciated, the “braking surface” referred to herein is the surface of the brake that contacts (or is intended to contact) an adjacent brake rotor when the brake is activated. The braking surface is therefore a surface of the brake pad which faces (or is intended to face) an adjacent brake rotor in use. The braking surface may be referred to as a “friction surface” of the brake pad. The brake pad and brake rotor will define opposed surfaces, the braking or friction surface of the brake pad being the surface that contacts (or is intended to contact) the surface of an adjacent brake rotor in use.

The brake pad can take any desired or suitable form. For example, the brake pad may comprise any suitable friction material (e.g. a ceramic, semi-metallic, metallic or carbon fiber material) on a support structure. In embodiments therefore the brake pad may comprise a support structure and a friction material thereon. In these embodiments the friction material defines the braking surface (rotor facing surface) and may define an opposite support structure facing surface. The friction material may be a body of friction material. The friction material may be a single (i.e. only one) layer of material, or may comprise a plurality of layers of one or more materials.

In one set of embodiments, the brake pad (or each brake pad) preferably has one or more openings in its braking surface for providing the fluid to the braking surface of the brake pad, with the pressurized fluid supply preferably being in fluid communication with the braking surface of the brake pad via the one or more openings.

The one or more openings are preferably positioned such that the brake pad does not tip or tilt when fluid is supplied to the surface of the brake pad. As will be appreciated, any inadvertent tipping or tilting of the brake pad may cause a portion of the braking surface to contact an adjacent brake rotor when the fluid is supplied to the braking surface. The one or more openings therefore preferably include one or more openings positioned substantially in the center of the braking surface of the brake pad. The one or more openings is preferably a single (i.e. only one) opening, wherein the single opening is positioned substantially in the center of the braking surface of the brake pad. However, in other embodiments the one or more openings may comprise a plurality of openings, wherein the plurality of openings are preferably concentrated substantially in the center of the braking surface of the brake pad and/or are evenly distributed across the central portion of the braking surface of the brake pad, or are evenly distributed across all of the braking surface of the brake pad (so as to balance out the reactive forces provided by the fluid as the fluid exists the openings). The one or more openings are also preferably positioned such that fluid can be supplied to substantially all of the braking surface of the brake pad.

The size and/or number of openings will depend on the size and type of brake system and/or brake pad. Generally, a larger brake pad and/or more resistive brake system mechanism (e.g. calipers) will require a larger opening and/or more openings.

The one or more openings may be any desired or suitable shape in cross-section. This refers to a cross-section taken in a plane through and parallel to the braking surface. For example, the or each opening may be circular, square, oval, racetrack shaped or oblong, or may be any other regular or irregular shape. The or each opening may be in the form of a slot. In a particular preferred embodiment, the or each opening is a racetrack shaped slot.

In any of the embodiments, the or each opening is preferably elongated and oriented such that (the longest dimension of) the or each opening runs substantially parallel to the longest dimension of the brake pad. These embodiments are particularly advantageous in that the fluid is effectively and evenly distributed to the majority of the surface of the brake pad (which is preferably also elongated). This can, for example, prevent or reduce the likelihood of the brake pad tipping or tilting. The use of an elongated slot also allows fluid to be distributed (e.g. from a smaller (circular) passage or tube) over a larger area. This means that, for a given fluid pressure, the force that is exerted by the fluid on an adjacent rotor, so as to separate the brake pad from the rotor, may be greater.

The length of the or each opening (the longest dimension of the or each opening) can be any desired or suitable length depending, for example, on the size and type of brake system or brake pad. However, the length of the or each opening is preferably less than 99% of the brake pad's length, more preferably less than 75% of the brake pad's length, and more preferably less than 50% of the brake pad's length. The length of the or each opening is preferably more than 1% of the brake pad's length, more preferably more than 5% of the brake pad's length, and more preferably more than 10% of the brake pad's length. The length of the or each opening may be between 2 mm and 50 mm.

The width of the or each opening (the shortest dimension of the or each opening) can be any desired or suitable width again depending, for example, on the size and type of brake system/pad. However, the width of the or each opening is preferably less than 99% of the brake pad's width, more preferably less than 75% of the brake pad's width, and more preferably less than 50% of the brake pad's width. The width of the or each opening is preferably more than 1% of the brake pad's width, more preferably more than 5% of the brake pad's width, and more preferably more than 10% of the brake pad's width. The width of the or each opening may be between 1 mm and 10 mm.

The depth of the or each opening is preferably the same as the thickness of the friction material of the brake pad. These embodiments are particularly advantageous in that the brake pad can wear down, but the opening will remain of substantially the same geometry. However, in other embodiments, each opening may be less than the depth of the friction material or may extend into the brake pad's support structure.

The or each opening may be an opening which extends all the way through the friction material from one side of the friction material (e.g. the braking surface side) to another side (e.g. other than the braking surface side).

In embodiments, the or each opening is an opening over and above any pores inherent in the material (e.g. friction material) defining the braking surface.

In an alternative set of embodiments, the brake pad (or each brake pad) preferably comprises a porous structure in its braking surface for providing the fluid to the braking surface of the brake pad, with the pressurized fluid supply preferably being in fluid communication with the braking surface of the brake pad via the porous structure. The porous structure may be provided by a suitable porous (braking or friction) material.

The porous structure is preferably positioned such that fluid can be supplied to substantially all of the braking surface of the brake pad via the porous structure. For example, the majority or all of the brake pad surface may be porous.

The majority or all of at least a friction material of the brake pad (i.e. not just the surface region) may also be porous. These embodiments are particularly advantageous in that the brake pad can wear down, but porous structure will remain on the surface of the brake pad. The porous structure may be provided by using porous friction material.

The porosity of the porous structure will depend on the size and type of brake system and/or brake pad. Generally, a larger brake pad and/or more resistive brake system mechanism (e.g. calipers) will require a porous structure having greater porosity (e.g. a larger region of porous structure on the surface of the brake pad and/or a more open porous structure).

It is envisaged that the braking surface may comprise one or more openings and a porous structure in the braking surface. For example, the braking surface may be provided by a porous structure having one or more openings therethrough.

In accordance with any of the embodiments of the invention, the one or more openings or porous structure may be in fluid communication with a passage or passages in the brake pad, the passage or passages being in fluid communication with the pressurized fluid supply. The fluid is preferably provided to the one or more openings or porous structure or passage or passages via a tube or tubes, preferably having a simple geometry (e.g. a circular cross-section).

The pressurized fluid supply is preferably capable of supplying pressurized fluid at a pressure and/or flow rate that is sufficient to separate the braking surface of the brake pad from an opposing brake rotor under non-braking conditions, i.e. provide a gap therebetween under non-braking conditions. The pressure and/or flow rate may also or instead be insufficient to separate the braking surface of the brake pad from the brake rotor under braking conditions.

The pressurized fluid supply is preferably capable of supplying pressurized fluid at one or more (different) pressures and/or flow rates under non-braking conditions. For example, the pressurized fluid supply (e.g. when activated) may be capable of supplying pressurized fluid at one (and only one) pressure and/or flow rate under non-braking conditions, with that pressure and/or flow rate being sufficient to initially separate the braking surface of the brake pad from the brake rotor under non-braking conditions and sufficient to maintain a suitable gap between the braking surface of the brake pad and the brake rotor under non-braking conditions.

However, the Applicant has identified that, in some brake systems, more force may be required to initially separate the braking surface of the brake pad from the brake rotor when non-braking conditions initially occur (i.e. directly after the end of a period of time during which braking conditions have occurred) than the force required to then maintain a gap between the braking surface of the brake pad and the brake rotor whilst non-braking conditions remain (i.e. until the next instance of braking conditions).

Thus, the pressurized fluid supply (e.g. when activated) is preferably capable of supplying pressurized fluid at two or more pressures and/or flow rates under non-braking conditions. For example, the pressurized fluid supply may be capable of supplying pressurized fluid at a first pressure and/or flow rate (or a first set of pressures and/or flow rates) at a first time under non-braking conditions and at a second pressure and/or flow rate (or a second set of pressures and/or flow rates) at a second subsequent time during that same instance of non-braking. The first pressure and/or flow rate (or first set of pressures and/or flow rates) is preferably sufficient to initially separate the braking surface of the brake pad from the brake rotor when non-braking conditions initially occur and the second pressure and/or flow rate (or second set of pressures and/or flow rates) is preferably sufficient to maintain a suitable gap between the braking surface of the brake pad and the brake rotor whilst non-braking conditions remain. In these embodiments, the first pressure and/or flow rate (or first set of pressures and/or flow rates) is preferably higher than the second pressure and/or flow rate (or second set of pressures and/or flow rates). These embodiments are particularly advantageous in that less power is generally required to supply fluid at a lower pressure and/or flow rate. Thus, switching the pressurized fluid supply from supplying fluid at a first higher pressure and/or flow rate to supplying fluid at a second lower pressure and/or flow rate whilst under non-braking conditions can reduce the power consumption of the brake system under non-braking conditions.

The “first set of pressures and/or flow rates” referred to above may comprise a first set of one or more discrete pressures and/or flow rates or a first (substantially continuous) range of pressures and/or flow rates. Similarly, the “second set of pressures and/or flow rates” referred to above may comprise a second set of one or more discrete pressures and/or flow rates or a second (substantially continuous) range of pressures and/or flow rates.

The fluid is preferably initially supplied at the first pressure and/or flow rate responsive to non-braking conditions occurring (e.g. when a brake pedal is released, an accelerator is activated etc.). The “first time” referred to above may therefore be at the time of (e.g. coinciding with, directly after, or shortly after (e.g. within 1 second of)) the initiation of non-braking conditions. Fluid at the first pressure and/or flow rate is preferably supplied (e.g. only supplied) for a predetermined period of time thereafter, with fluid at the second pressure and/or flow rate preferably being supplied directly after or shortly after (e.g. within 1 second of) that predetermined period of time expiring. The predetermined period of time is preferably a period of time that is less than 5 seconds, more preferably a period of time that is less than 1 second, and most preferably a period of time that is less than 0.5 seconds. Fluid at the second pressure and/or flow rate is preferably then supplied at least whilst non-braking conditions remain (or for the majority of time whilst non-braking conditions remain). Fluid at the second pressure and/or flow rate may also be supplied (and continue to be supplied) when and/or during any subsequent instance of braking conditions.

The distance of separation or gap between the brake pad and brake rotor provided by embodiments of the present invention need only be enough so that the surface of the brake pad does not contact an adjacent brake rotor. The separation is preferably of the order of 1 to 100 microns, preferably of the order of 10 microns. The gap is preferably provided across substantially the entire surface of the brake pad.

As will be appreciated, the capabilities of the pressurized fluid supply will depend on the type and size of the brake system, the number and size of openings in the surface of the brake pad, the porosity of the brake pad, and/or the number of brake pads that are supplied with pressurized fluid. However, the pressurized fluid supply is preferably configured to supply pressurized fluid at one or more pressures or a plurality of pressures or a substantially continuous range of pressures between 0.5 kPa and 700 kPa, more preferably between 0.5 kPa and 200 kPa, even more preferably between 0.5 kPa and 50 kPa, and most preferably between 0.5 kPa and 40 kPa.

The pressurized fluid supply can be powered in any desired or suitable way. However, the pressurized fluid supply is preferably powered either directly or indirectly by an engine of the vehicle (an engine that drives the wheels of the vehicle). For example, the pressurized fluid supply may be powered by (directly coupled to, e.g. with suitable connections and/or gearing) an alternator shaft of an engine of the vehicle or may be powered by (directly coupled to, e.g. with suitable connections and/or gearing) a drive train of an engine. Alternatively, the pressurized fluid supply may be powered by electrical power generated by an engine of the vehicle, for example a 12V DC or 24V DC power supply, such as the power supply which is provided to or by the cigarette lighter of a vehicle. These embodiments are particularly advantageous in that a dedicated supply of power (e.g. a battery or generator) is not needed in or for the braking system.

The pressurized fluid supply preferably comprises a compressor or pump capable of producing the necessary pressure and/or flow rate. Generally, a larger brake pad and/or more resistive brake mechanism (e.g. calipers) will require a pressurized fluid supply that is capable of supplying fluid at a higher pressure and/or flow rate. In embodiments in which fluid at a plurality of different pressures and/or flow rates or a substantially continuous range of different pressures and/or flow rates is provided, those different pressures and/or flow rates may be provided by operating the compressor or pump in different configurations or at different speeds (e.g. different speeds in terms of revolutions per minute (rpm) of the motor or impeller of the compressor or pump). The compressor or pump may be stepped between different discrete configurations or speeds (rpms), or the configuration or speed (rpm) of the compressor or pump may be substantially continuously variable. In embodiments, the motor for the compressor or pump is preferably a brushless motor. The speed of such motors is typically relatively easy to control.

As will be appreciated, the system is configured to provide fluid from the pressurized fluid supply to the braking surface of the brake pad at least under non-braking conditions. This is preferably achieved by a system control means of the brake system. For example, controlling the compressor or pump to supply fluid at a desired time and/or at a desired pressure and/or flow rate can be achieved by the system control means. It will be appreciated that any of the steps involved in providing fluid from the pressurized fluid supply to the braking surface may be carried out by the system control means of the system. Thus, references such as “the system being configured such that” may be interchanged with “the system comprising system control means being configured such that”.

In preferred embodiments, the system (or system control means) is preferably configured to provide fluid from the pressurized fluid supply to the braking surface of the brake pad only under non-braking conditions. Thus, the system (or system control means) may be configured to activate the pressurized fluid supply only under non-braking conditions and/or deactivate the pressurized fluid supply under braking conditions.

The activation/deactivation may be achieved by any desired or suitable means. For example, the power provided to the pressurized fluid supply may be applied or increased to activate the pressurized fluid supply and/or the power provided to the pressurized fluid supply may be reduced or removed to deactivate the pressurized fluid supply. A system control means may be arranged to activate/deactivate the pressurized fluid supply in any of these ways.

Similarly, the brake system may also or instead comprise a pressurized fluid supply valve in fluid communication between the pressurized fluid supply and the braking surface of the brake pad. The system (or system control means) is preferably configured such that the pressurized fluid valve is opened under non-braking conditions so as to fluidly connect the pressurized fluid supply to the braking surface of the brake pad and/or is preferably configured such that the pressurized fluid valve is closed under braking conditions so as to isolate the braking surface of the brake pad from the pressurized fluid supply.

However, the system (or system control means) may provide fluid from the pressurized fluid supply to the braking surface of the brake pad under braking conditions as well as non-braking conditions. In these arrangements, the brake system of the present invention is preferably arranged so as to not reduce the braking efficiency (or so as to only insignificantly reduce the braking efficiency) of the vehicle when the pressurized fluid is supplied to the braking surface of the brake pad. For example, the fluid may be supplied at a first (higher) pressure and/or flow rate (sufficient to separate the braking surface of the brake pad from the brake rotor and/or sufficient to maintain a gap between the braking surface of the brake pad and the brake rotor) for at least some of the time under non-braking conditions, and at a second (lower) pressure and/or flow rate (insufficient to separate the braking surface of the brake pad from the brake rotor and/or insufficient to maintain a gap between the braking surface of the brake pad and the brake rotor) for at least some of the time under braking conditions.

In some embodiments, a pressure release valve may be provided in fluid communication with the pressurized fluid supply. The pressure release valve is preferably configured such that, when the brake is activated and the flow of fluid to the brake surface of the brake system is reduced by the reduced gap between the brake pad and an adjacent brake rotor, the resultant build up in pressure of the pressurized fluid from the pressurized fluid supply is relieved by the pressure release valve. This can prevent damaging the brake system and can reduce the amount of force required to activate the brake (i.e. the amount of force required to bring the brake pad into contact with the brake rotor).

In preferred embodiments, the braking efficiency of the brake system is also or instead passively or actively improved. For example, the brake system preferably comprises a fluid removal means in fluid communication with the braking surface of the brake pad, the system (or system control means) being configured to operate the fluid removal means so as to allow the removal of fluid from the braking surface of the brake pad under braking conditions (and preferably only under braking conditions).

Advantageously, by passively or actively removing fluid from the braking surface of the brake pad, the brake pad can be brought towards any adjacent brake rotor using a reduced amount of force or with the assistance of negative pressure. This can reduce the activation distance and time for the brake system under braking conditions.

These arrangements are believed to be new and advantageous in their own right, and not merely in the context of the above described aspects and embodiments.

Thus, according to another aspect of the present invention there is provided a brake system comprising: a brake pad having a braking surface; and a fluid removal means in fluid communication with the braking surface of the brake pad; wherein the system is configured such that the fluid removal means allows the removal of fluid from the braking surface of the brake pad under braking conditions.

This aspect of the present invention may comprise any or all of the preferred or optional features discussed herein as appropriate. Furthermore, as will be appreciated, the features of this aspect of the present invention and its embodiments (for example, the brake pad, system control means, etc.) may correspond to (may be) the features already discussed above.

In one set of embodiments, the brake pad preferably has one or more openings in its braking surface for removal of the fluid from the braking surface of the brake pad, with the fluid removal means preferably being in fluid communication with the braking surface of the brake pad via the one or more openings. The one or more openings preferably correspond to (are) the one or more openings already discussed above.

In an alternative set of embodiments, the brake pad preferably comprises a porous structure in its braking surface for removal of the fluid from the braking surface of the brake pad, with the fluid removal means preferably being in fluid communication with the braking surface of the brake pad via the porous structure. The porous structure preferably corresponds to (is) the porous structure already discussed above.

The fluid removal means preferably comprises a fluid removal valve in fluid communication with the braking surface of the brake pad. The system (or system control means) is preferably configured to open the fluid removal valve so as to vent the fluid to atmosphere under braking conditions and/or close the fluid removal valve under non-braking conditions. Alternatively, the fluid removal means may comprise a fluid suction device.

In some embodiments, the fluid removal means comprises both a fluid removal valve and a fluid suction device, the fluid removal valve being in fluid communication between the fluid suction device and the braking surface of the brake pad. The system (or system control means) is preferably configured to open the fluid removal valve under braking conditions so as to vent the fluid to the fluid suction device and/or close the fluid removal valve under non-braking conditions.

The system (or system control means) is preferably configured to activate the fluid suction device under braking conditions and/or deactivate the fluid suction device under non-braking conditions. The activation/deactivation may be achieved by any desired or suitable means. For example, the power provided to the fluid suction device may be applied or increased to activate the fluid suction device and/or the power provided to the fluid suction device may be reduced or removed to deactivate the fluid suction device.

The fluid suction device may comprise any desired or suitable device. However, the fluid suction device is preferably a vacuum or the aforementioned pressurized fluid supply (compressor or pump) operated in reverse or connected in reverse (e.g. using a suitable valve arrangement).

The pressurized fluid supply may be operated in reverse by the input to the pressurized fluid supply/fluid suction device (that once took in fluid) becoming the output of the pressurized fluid supply/fluid suction device (that now sends out fluid). Similarly, the output of the pressurized fluid supply/fluid suction device (that once sent out fluid) can become the input to the pressurized fluid supply/fluid suction device (that takes in fluid). In this embodiment, the pressurized fluid supply/fluid suction device may have a first input/output and a second input/output. When acting as a pressurized fluid supply, the first input/output takes in fluid from the surrounding atmosphere and the second input/output provides fluid to the braking surface. When acting as a fluid suction device, the second input/out takes in fluid from the braking surface and the first input/output vents the fluid to atmosphere.

However, in a particularly preferred embodiment, the pressurized fluid supply operates in the same direction but is connected in reverse (e.g. using a suitable valve arrangement). In this embodiment, the pressurized fluid supply/fluid suction device has a (permanent) input for receiving fluid and a (permanent) output for providing fluid. When acting as a pressurized fluid supply, the input is placed in fluid communication with the surrounding atmosphere (e.g. by a first valve) and the output is placed in fluid communication with the braking surface (e.g. by a second valve). When acting as a fluid suction device, the input is placed in fluid communication with the braking surface (e.g. by the first valve) and the output is placed in fluid communication with the surrounding atmosphere (e.g. by the second valve).

These arrangements are particularly advantageous in that a single device can act both as a pressurized fluid supply and as a fluid suction device, although not at the same time.

It is not necessary for the fluid removal means to be operated all the time under braking conditions, and it may be desirable to operate the fluid removal means only for a predetermined amount of time for each given braking operation so as to reduce power consumption. In these embodiments, the fluid removal means is preferably operated for between 0.5 to 5 seconds for or during a given braking operation.

In some embodiments, the fluid removal means can also be used to remove and/or collect brake dust generated by braking operations. In some embodiments, the fluid removal means may be operated both under braking conditions (e.g. to facilitate the brake pad being brought towards the brake rotor and to allow brake dust to be removed/collected during braking) and/or under non braking conditions (e.g. to allow brake dust to be removed/collected after braking). Thus, the fluid removal means may be operable to remove fluid and any brake dust from the braking surface of the brake pad under braking and/or non-braking conditions.

In other embodiments, a dust removal means other than the fluid removal means mentioned above can be provided at the brake pad to remove and/or collect brake dust generated by braking operations.

Accordingly, in some embodiments, a dust removal means (e.g. the fluid removal means mentioned above or some other means) may be provided for the purpose of removing brake dust generated by braking operations. The removal of brake dust in this way (i.e. directly at the brake pad) can reduce the amount of polluting brake dust released into the atmosphere, and may increase brake pad efficiency (e.g. by preventing the braking material of the brake pad from becoming clogged with brake dust).

These arrangements are believed to be new and advantageous in their own right, and not merely in the context of the above described aspects and embodiments.

Thus, according to another aspect of the present invention there is provided a brake system comprising: a brake pad having a braking surface; and a brake dust removal means in fluid communication with the brake pad; wherein the system is configured such that the brake dust removal means removes fluid containing brake dust from the brake pad, e.g. under non-braking conditions and/or under braking conditions.

This aspect of the present invention may comprise any or all of the preferred or optional features discussed herein as appropriate. Furthermore, as will be appreciated, the features of this aspect of the present invention and its embodiments (for example, the brake pad, system control means, etc.) may correspond to (may be) the features already discussed above.

In one set of embodiments, the brake pad preferably has one or more openings in or adjacent to its braking surface for removal of the fluid containing brake dust from the brake pad, with the brake dust removal means preferably being in fluid communication with the brake pad via the one or more openings.

The opening(s) for removing fluid containing brake dust may be provided in the brake pad itself (e.g. in the braking material) or may be provided about the periphery of the brake pad (e.g. not in the braking material).

In some embodiments, the one or more openings for removing fluid containing brake dust may correspond to (may be) the one or more openings already discussed above. Alternatively, the brake pad may comprise an opening or openings for providing fluid to the brake pad (e.g. the braking surface) and/or a different opening or openings for removing fluid containing brake dust from the brake pad.

In some preferred embodiments, the opening(s) for removing fluid containing brake dust may comprise one or more perimeter voids (e.g. defined by one or more tracks or grooves) located about the perimeter of the brake pad (either in the braking surface or adjacent to the braking surface). The perimeter void(s) may be provided by a circumferential track or groove in the braking surface or adjacent to the braking surface. A peripheral wall may thereby be formed by an outer peripheral portion of the brake pad, and the circumferential track or groove may provide the perimeter void between the outer peripheral portion of the brake pad and an inner portion of the brake pad. In these embodiments, the opening(s) for providing fluid to the braking surface (if provided) preferably comprises one or more openings located substantially in the center of the brake pad (i.e. in the braking surface).

In other preferred embodiments, the opening(s) for removing fluid containing brake dust comprise one or more openings about the perimeter of the brake pad (but not in the braking surface). In these embodiments, the opening(s) for providing fluid to the braking surface (if provided) preferably comprises one or more openings located substantially in the center of the brake pad. One or more openings for providing fluid to the brake pad may also be provided about the perimeter of the brake pad (but not in the braking surface). The perimeter opening(s) for removing fluid containing brake dust are preferably provided towards or at an opposite edge of the brake pad to the perimeter opening(s) for providing fluid to the brake pad.

The perimeter opening(s) for removing fluid containing brake dust are preferably provided towards or at the trailing edge of the brake pad (the trailing edge being the edge away from which the brake rotor rotates when the vehicle is moving forwards). The perimeter opening(s) for providing fluid to the brake pad are preferably provided at the leading edge of the brake pad (the leading edge being the edge towards which the brake rotor rotates when the vehicle is moving forwards). This may allow brake dust to be swept by the brake rotor into the perimeter opening(s) for removing fluid containing brake dust.

In some embodiments, a peripheral wall, which may be defined or provided by a skirt, may be provided around the sides of the brake pad and/or the brake rotor to prevent brake dust from the braking surface of the brake pad from entering the surrounding atmosphere. The peripheral wall preferably spans the gap between the brake pad and the brake rotor so as to prevent brake dust from the braking surface of the brake pad from entering the surrounding atmosphere at least under braking conditions. The peripheral wall may be integrally formed with the brake pad structure or may be a separate structure attached to the brake pad structure.

In preferred embodiments, the peripheral wall directs fluid which is provided by a first perimeter opening(s) about (around the outside of) the brake pad under braking conditions. The fluid entrains brake dust before being removed by a second perimeter opening(s).

The peripheral wall may be attached to, or form part of, a translating portion of the brake pad structure (i.e. a portion of the brake pad structure which moves away and towards the brake rotor under braking and non braking), such as the support structure of the brake pad. In these embodiments, the peripheral wall may span the gap between the brake pad and the brake rotor so as to prevent brake dust from the braking surface of the brake pad from entering the surrounding atmosphere (only) under braking conditions.

Alternatively, the peripheral wall may be attached to, or form part of, the brake rotor or a non-translating portion of the brake pad structure (i.e. a portion of the brake pad structure which does not move away and towards the brake rotor under braking and non braking). In these embodiments, the peripheral wall may span the gap between the brake pad and the brake rotor so as to prevent brake dust from the braking surface of the brake pad from entering the surrounding atmosphere under braking and non braking conditions.

The peripheral wall may be attached to a translating portion of the brake pad structure or a non-translating portion of the brake pad structure or brake rotor by a resilient mounting (e.g. a spring mounting), with the resilient mounting ensuring that the peripheral wall spans the gap between the brake pad and the brake rotor so as to prevent brake dust from the braking surface of the brake pad from entering the surrounding atmosphere under braking and/or non braking conditions.

When spanning the gap between the brake pad and the brake rotor, the peripheral wall may be placed in light contact with the brake rotor. The peripheral wall may wear at substantially the same rate or faster than the braking material of the brake pad.

The peripheral wall may be constructed from any suitable material or materials (e.g. a composite material) able to withstand brake pad operating temperatures, such as a metallic or semi-metallic material, a ceramic material, silicone rubber or foam, an aramid fiber material (e.g. Kevlar®) or carbon fiber. The peripheral wall (e.g. skirt) is preferably flexible, but may be rigid or semi-rigid.

The brake dust removal means preferably comprises a dust filter/collector in fluid communication with the brake pad for collecting brake dust from the fluid which is removed from the brake pad.

The brake dust removal means may comprise a fluid suction device for motivating fluid containing dust such that the fluid containing dust is removed from the brake pad and passes through the dust filter/collector. The system (or system control means) is preferably configured to operate the fluid suction device, thereby causing fluid containing dust from the braking surface to pass through dust filter/collector.

The brake dust removal means may comprise a dust removal valve in fluid communication with the brake pad and the dust filter/collector. The system (or system control means) is preferably configured to open the fluid removal valve, thereby causing fluid containing dust from the braking surface to pass through the dust filter/collector.

In some embodiments, the brake dust removal means comprises both a dust removal valve and a fluid suction device, the dust removal valve being in fluid communication between the fluid suction device and the brake pad. The system (or system control means) is preferably configured to open the dust removal valve thereby causing fluid containing dust from the braking surface to pass through dust filter/collector, and causing filtered fluid to enter the fluid suction device.

The system (or system control means) is preferably configured to operate the dust removal valve and/or activate the fluid suction device under braking conditions (e.g. during a braking operation) and/or under non braking conditions (e.g. after a braking operation). The activation may be achieved by any desired or suitable means. For example, the power provided to the fluid suction device may be applied or increased to activate the fluid suction device.

The fluid suction device may comprise any desired or suitable device. For example, the fluid suction device may be a vacuum or the aforementioned pressurized fluid supply (compressor or pump) operated in reverse or connected in reverse (e.g. using a suitable valve arrangement).

The pressurized fluid supply may be operated in reverse by the input to the pressurized fluid supply/fluid suction device (that once took in fluid) becoming the output of the pressurized fluid supply/fluid suction device (that now sends out fluid). Similarly, the output of the pressurized fluid supply/fluid suction device (that once sent out fluid) can become the input to the pressurized fluid supply/fluid suction device (that takes in (filtered) fluid). In this embodiment, the pressurized fluid supply/fluid suction device may have a first input/output and a second input/output. When acting as a pressurized fluid supply, the first input/output takes in fluid from the surrounding atmosphere and the second input/output provides fluid to the braking surface. When acting as a fluid suction device, the second input/out takes in (filtered) fluid from the brake pad via the filter and the first input/output vents the fluid to atmosphere.

However, in other embodiments, the pressurized fluid supply operates in the same direction but is connected in reverse (e.g. using a suitable valve arrangement). In these embodiments, the pressurized fluid supply/fluid suction device has a (permanent) input for receiving (filtered) fluid and a (permanent) output for providing fluid. When acting as a pressurized fluid supply, the input is placed in fluid communication with the surrounding atmosphere (e.g. by a first valve) and the output is placed in fluid communication with the braking surface (e.g. by a second valve). When acting as a fluid suction device, the input is placed in fluid communication with the brake pad (e.g. by the first valve) and the output is placed in fluid communication with the surrounding atmosphere (e.g. by the second valve).

As mentioned above, these arrangements are particularly advantageous in that a single device can act both as a pressurized fluid supply and as a fluid suction device, although not at the same time.

In some embodiments in which the brake pad comprises a first opening or first openings for providing fluid to the brake pad, and a second opening or second openings for removing fluid containing brake dust from the brake pad, the fluid suction device may be configured so as to be able to simultaneously provide fluid to the brake pad and to remove fluid containing brake dust from the brake pad. In these embodiments, the pressurized fluid supply/fluid suction device may have a (permanent) input for receiving (filtered) fluid and a (permanent) output for providing fluid. In acting as a pressurized fluid supply and as a fluid suction device, the input is in fluid communication with the brake pad via the second opening(s) (e.g. placed in fluid communication by a first valve) and the output is in fluid communication with the brake pad via the first opening(s) (e.g. placed in fluid communication by a second valve). Fluid may then be (continuously) circulated from the pressurized fluid supply/fluid suction device to the brake pad via the first opening(s) and back to the pressurized fluid supply/fluid suction device from the brake pad via the second opening(s).

These arrangements are particularly advantageous in that a single device can act both as a pressurized fluid supply and as a fluid suction device at the same time.

A particularly preferred embodiment, as discussed above, has a skirt, first perimeter opening(s) for removing fluid containing brake dust, second perimeter opening(s) for providing fluid to the brake pad, and centrally located opening(s) for providing fluid to the brake surface. A diverting valve is preferably provided in fluid communication with the output of a pressurized fluid supply. The diverting valve is preferably in fluid communication with the second perimeter opening(s) and the centrally located opening(s).

In a first mode of operation (e.g. under non-braking conditions), the diverting valve is configured such that some or all fluid from the pressurized fluid supply is provided to the braking surface via the centrally located opening(s). In the first mode of operation the fluid provides a gap between the brake pad and the adjacent brake rotor, as discussed above.

In a second mode of operation (e.g. under braking conditions), the diverting valve is configured such that some or all fluid from the pressurized fluid supply is instead provided to the brake pad via the second perimeter opening(s). In the second mode of operation the fluid passes about (around the outside of) the brake pad and entrains brake dust, and the fluid and dust is then removed by the first perimeter opening(s), as discussed above.

The diverting valve may be operated by the system control means. The diverting valve may be mechanically or electromechanically operable. In a preferred embodiment, the diverting valve is a solenoid valve under the control of the system control means.

Alternatively, the diverting valve may be pressure operated. For example, under braking conditions, when the brake pad is brought into contact with the brake rotor, the centrally located opening(s) may be closed off. This may increase the back pressure of the fluid being provided by the diverting valve to the centrally located opening(s). Once a predetermined back pressure is reached, the diverting valve may switch to providing more or all of the fluid from the pressurized fluid supply to the second perimeter opening(s). Similarly, under non-braking conditions, when the brake pad is moved away from the brake rotor, the centrally located opening(s) may be opened. This may decrease the back pressure of the fluid being provided to the centrally located opening(s). Once a predetermined pressure is reached, the diverting valve may switch to providing more or all of the fluid from the pressurized fluid supply to the centrally located opening(s).

In embodiments, the brake dust removal means may be operated for some or all of the time under non braking conditions, and/or for some or all of the time under braking conditions. In a preferred embodiment, the brake dust removal means may be operated under braking conditions and non-braking conditions.

According to another aspect of the present invention there is provided a brake pad assembly comprising: a brake pad having a braking surface; a peripheral wall provided about the periphery of the braking surface of the brake pad, wherein a perimeter void is provided between the peripheral wall and at least a portion of the brake pad, the perimeter void being in fluid communication with the braking surface of the brake pad; and a first set of one or more openings in fluid communication with the perimeter void for removing brake dust from the braking surface of the brake pad.

As with other aspects and embodiments of the present invention, this aspect of the present invention is particularly advantageous in that the brake dust can be removed directly at the brake pad. In particular, brake dust from the braking surface can be collected at the brake pad by the perimeter void which is provided between the peripheral wall and at least a portion of the brake pad, and can then be removed via the first set of one or more openings. This aspect of the present invention also provides a compact design since the peripheral wall is provided about the periphery of the braking surface. The peripheral wall and perimeter void are therefore in close proximity to the brake pad, and can collect and remove brake dust “at source”.

The above aspect of the present invention may comprise any or all of the preferred or optional features discussed herein as appropriate. Furthermore, as will be appreciated, the features of this aspect of the present invention and its embodiments (for example, the brake pad, etc.) may correspond to (may be) the features already discussed above.

In some embodiments, as discussed above, the peripheral wall may be provided by an outer peripheral portion of the brake pad. The peripheral void may therefore be provided between the outer peripheral portion of the brake pad and an inner portion of the brake pad. In preferred embodiments, the perimeter void is formed between (is bounded by) the outer peripheral portion of the brake pad and the inner portion of the brake pad.

In other embodiments, the brake pad may have one or more side surfaces and the peripheral wall may be provided around the one or more side surfaces of the brake pad. The peripheral void may be provided between the peripheral wall and the one or more side surfaces of the brake pad. In preferred embodiments, the perimeter void is formed between (is bounded by) the peripheral wall and the one or more sides surfaces of the brake pad. In other embodiments, the perimeter void is formed between (is bounded by) the peripheral wall and a further (inner) peripheral wall which surrounds (and is, for example, attached to or directly bonded to) the one or more sides surfaces of the brake pad.

In some embodiments, as discussed above, the peripheral wall(s) may be provided by a skirt, which may be flexible or rigid. The peripheral wall(s) (e.g., the skirt) is preferably formed from silicone, for example silicone rubber or silicone foam.

In some embodiments, the brake pad assembly may comprise a plurality of partitions. The partitions may space the peripheral wall from the one or more side surfaces of the brake pad (or the further (inner) peripheral wall). The partitions may also or instead provide channels located between the peripheral wall and the one or more side surfaces of the brake pad (or the further (inner) peripheral wall). The channels are preferably formed between (are bounded by) adjacent partitions (for example, together with the peripheral wall and the one or more sides surfaces of the brake pad (or the further (inner) peripheral wall)).

The channels are preferably in fluid communication between the perimeter void and the braking surface of the brake pad. The channels therefore allow fluid containing brake dust from the braking surface to flow into the perimeter void.

Some or all of the partitions may be at least partially rectilinear, for example rectangular and/or square, in cross-section. Some or all of the partitions may also or instead be at least partially curved, for example oblong, elliptical and/or circular, in cross-section.

In a preferred embodiment the partitions are integrally formed with the peripheral wall (and the further (inner) peripheral wall if provided). For example, the peripheral wall(s) and partitions may be provided as a unitary (e.g. molded) (skirt) structure). The peripheral wall(s) can then be fitted (e.g. retrofitted) to a conventional brake pad. In other embodiments however, the partitions are integral to the brake pad. For example, the brake pad is machined or cast (die cast) so as to have partitions about its periphery. A (e.g. smooth) peripheral wall can then be fitted (e.g. retrofitted) around the machined or cast brake pad.

In some embodiments, the first set of one or more openings are provided through the peripheral wall. In some embodiments, the brake pad assembly comprises a first set of one or more passages (e.g. spigots or tubes) for removing brake dust from the braking surface of the brake pad. The first set of one or more passages are preferably in fluid communication with the perimeter void via the first set of one or more openings.

In a preferred embodiment, the first set of one or more openings comprises a first opening and a second opening. The first opening is preferably provided at an opposite side of the brake pad to the second opening. For example, the first opening may be at a trailing edge of the brake pad and the second opening may be at a leading edge of the brake pad.

In some embodiments, as discussed above in relation to the other aspects and embodiments, the brake pad assembly comprises a second set of one or more openings for providing fluid to the braking surface of the brake pad. For example, as discussed above in relation to the other aspects and embodiment, the second set of one or more openings may be provided in the braking surface of the brake pad. For example, as discussed above in relation to the other aspects and embodiments, the second set of one or more openings may comprise one or more openings located substantially in the center of the braking surface of the brake pad.

In some embodiments, the brake pad assembly comprises a second set of one or more passages (e.g. spigots or tubes) for providing fluid to the braking surface of the brake pad. The second set of one or more passages are preferably in fluid communication with the braking surface of the brake pad via the second set of one or more openings.

In some embodiments, the brake pad assembly comprises a set of one or more openings for providing fluid to the perimeter void. This set of one or more openings may include (may be) one or more of the first set of one or more openings (albeit configured, e.g. using a suitable valve and/or control means, so as to sometimes (e.g. under non-braking conditions) remove fluid from the perimeter void and sometimes (e.g. under braking conditions) provide fluid to the perimeter void). The set of one or more openings may also or instead include (may be) a different set of one or more openings to the first set of one or more openings. The set of one or more openings for providing fluid to the perimeter void may be provided through the peripheral wall.

In some embodiments, the brake pad assembly comprises a set of one or more passages (e.g. spigots or tubes) for providing fluid to the perimeter void. This set of one or more passages may include (may be) one or more of the first set of one or more passages (albeit configured, e.g. using a suitable valve and/or control means, so as to sometimes (e.g. under non-braking conditions) remove fluid from the perimeter void and sometimes (e.g. under braking conditions) provide fluid to the perimeter void). The set of one or more passages for providing fluid to the perimeter void may also or instead include (may be) a different set of one or more passages (e.g. spigots or tubes) to the first set of one or more passages. The set of one or more passages for providing fluid to the perimeter void are preferably in fluid communication with the perimeter void via the set of one or more openings for providing fluid to the perimeter void.

As discussed above, the above aspect and embodiments of the present invention provide a compact design for dust collection. The brake pad assembly may accordingly comprise a brake caliper, wherein the brake pad and the peripheral wall (skirt) are mounted in (within) the brake caliper.

According to another aspect of the present invention there is provided a brake system comprising a brake pad assembly as discussed above. The brake system may comprise, for example as discussed above in relation to other aspects and embodiments, a brake dust removal means in fluid communication with the first set of one or more openings. Similarly, as discussed above in relation to other aspects and embodiments, the system may be configured such that the brake dust removal means removes fluid containing brake dust from the braking surface via the first set of one or more openings, e.g. under non-braking conditions and/or under braking conditions.

The above aspect of the present invention may comprise any or all of the preferred or optional features discussed herein as appropriate. Furthermore, as will be appreciated, the features of this aspect of the present invention and its embodiments (for example, the brake pad, system control means, etc.) may correspond to (may be) the features already discussed above.

For example, as discussed above in relation to the other aspects and embodiments, the brake system may comprise a pressurized fluid supply having an output for providing pressurized fluid to the braking surface and/or the perimeter void. The system may be configured such that the pressurized fluid supply provides pressurized fluid to the braking surface of the brake pad (only) under non-braking conditions. In some embodiments, the system may be configured such that the pressurized fluid supply provides pressurized fluid to the perimeter void under non-braking conditions and/or under braking conditions, but preferably (only) under braking conditions.

Similarly, as discussed above in relation to the other aspects and embodiments, the pressurized fluid supply may be configured to supply fluid at a pressure and/or a flow rate that is sufficient to separate the braking surface of the brake pad from a braking surface of an opposing brake rotor under non-braking conditions and/or that is insufficient to separate the braking surface of the brake pad from a braking surface of an opposing brake rotor under braking conditions.

Furthermore, as discussed above in relation to the other aspects and embodiments, the brake dust removal means may comprise a dust filter or a dust collector in fluid communication with the perimeter void for collecting brake dust from fluid which is removed from the brake pad.

Furthermore, as discussed above in relation to the other aspects and embodiments, the brake dust removal means may comprise a fluid suction device for motivating fluid containing dust, such as a vacuum or the pressurized fluid supply operated in reverse or connected in reverse (e.g. in the manner already discussed above).

In any of the above aspects and embodiments, the brake system may comprise fluid conditioning means (e.g. air conditioning means) for warming and/or drying and/or filtering fluid to be provided to the braking surface and/or the perimeter void. This can prevent, for example, moisture entering the brake pad assembly and forming a slurry from the brake dust.

The “braking conditions” and/or “braking operation” referred to above can be defined in any suitable way. For example, and preferably, the braking conditions and/or braking operation may comprise the brake being activated, for example via a brake pedal or lever (e.g. hand brake) of the vehicle, and/or an accelerator or throttle of the vehicle not (or no longer) being activated, and/or a clutch mechanism of the vehicle not (or no longer) being activated, and/or a cruise control system for the vehicle being deactivated.

Similarly, the “non-braking conditions” referred to above can be defined in any suitable way. For example, and preferably, the non-braking conditions may comprise the brake being deactivated, for example a brake pedal or lever (e.g. hand brake) of the vehicle not being in use, and/or an accelerator or throttle of the vehicle being activated, and/or a gear change or a clutch mechanism of the vehicle being activated, and/or a cruise control system for the vehicle being activated.

The system (or system control means) may comprise means for detecting braking conditions and/or a braking operation and/or non-braking conditions. In embodiments, the brake system preferably comprises a sensor arrangement (e.g. in communication with the system control means) for detecting when a brake pedal and/or an accelerator or throttle and/or a cruise control system is being activated.

The “fluid” referred to above can take any suitable form. For example, and preferably, the fluid may be a gas, for example an inert gas or air. The use of air is particularly advantageous in that a dedicated supply of gas (e.g. a gas cylinder) is not needed in or for the braking system.

As discussed above, the system may be monitored and/or controlled by system control means. The system control means may have any desired or suitable form. The system control means may be mechanical, electronic, or may be a combination thereof. For example, the system may comprise one or more processors (e.g. for monitoring/controlling the braking system), sensors (e.g. for detecting whether or not a braking condition exists, for detecting pressurized fluid pressure etc.), valve actuators (e.g. for the pressurized fluid supply valve and/or fluid removal valve), voltage/current supplies (e.g. for the pressurized fluid supply and/or fluid suction device). The system control means may be part of a control system for a vehicle. The system control means may comprise any one or ones of the means listed above.

According to another aspect of the present invention there is provided a vehicle comprising the brake pad assembly or brake system described herein. This aspect of the present invention may comprise any or all of the preferred or optional features discussed herein as appropriate.

The vehicle may be a road or motor vehicle (such as bicycle, an automobile (car, van, etc.), motorcycle, quad bike, truck or bus), may be a rail vehicle (such as a tram or train), or may be an aircraft (having, for example, a landing gear comprising the brake pad assembly or brake system). The vehicle may be any one or ones of the vehicles listed above. The vehicle may have one or more brake pads (e.g. for some or all of the wheels of the vehicle), with one or more or each of those brake pads having pressurized fluid supplied to its surface in the manner described herein and/or fluid/dust removal openings and/or fluid/dust removal means in the manner discussed herein.

According to another aspect of the present invention there is provided a method using a brake system having a brake pad (preferably the brake system described herein), comprising: providing pressurized fluid to the braking surface of the brake pad under non-braking conditions.

According to another aspect of the present invention there is provided a method of using a brake system having a brake pad (preferably the brake system described herein), comprising: removing fluid from the braking surface of the brake pad under braking conditions.

According to another aspect of the present invention there is provided a method of using a brake system having a brake pad (preferably the brake system described herein), comprising: removing fluid containing dust from the brake pad, e.g. under braking conditions and/or under non-braking conditions.

According to another aspect of the present invention there is provided a method of using a brake pad assembly (preferably the brake pad assembly described herein) or a brake system (preferably the brake system described herein), comprising: removing fluid containing brake dust from a braking surface of a brake pad via a first set of one or more openings, e.g. under braking conditions and/or under non-braking conditions.

These aspects of the present invention may comprise the provision or use of any one or more of, or all of, the preferred or optional features discussed herein as appropriate.

According to another aspect of the present invention there is provided a control system for a brake system (preferably the brake system described herein) and/or for a vehicle, the control system being configured and/or arranged to implement any of one or more of, or all of, the methods described herein.

According to another aspect of the present invention there is provided a computer readable medium comprising software which, when run on a control system for a brake system (preferably for the brake system described herein) and/or for a vehicle, implements any one or more of, or all of, the methods described herein. The computer readable medium may be a physical, tangible, or non-transitory medium, such as a diskette, CD ROM, ROM, RAM, flash memory or hard disk.

As will be appreciated the features of the brake system described above may be retrofitted to an existing conventional brake system.

Thus, according to another aspect of the present invention there is provided a kit for modifying a brake system having a brake pad, the kit comprising: a pressurized fluid supply for placing in fluid communication with the braking surface of the brake pad; and system control means configured to operate the pressurized fluid supply so as to provide fluid to the braking surface of the brake pad under non-braking conditions.

According to another aspect of the present invention there is provided a kit for modifying a brake system having a brake pad, the kit comprising: a fluid removal means for placing in fluid communication with the braking surface of the brake pad; and system control means configured to operate the fluid removal means so as to allow the removal of fluid from the braking surface of the brake pad under braking conditions.

According to another aspect of the present invention there is provided a kit for modifying a brake system having a brake pad, the kit comprising: a dust removal means for placing in fluid communication with the brake pad; and system control means configured to operate the dust removal means so as to remove fluid containing brake dust from the brake pad under non-braking conditions and/or under braking conditions.

According to another aspect of the present invention there is provided a kit for modifying a brake pad having a braking surface, the kit comprising: a peripheral wall for providing about the periphery of the braking surface of the brake pad, such that a perimeter void is provided between the peripheral wall and at least a portion of the brake pad, the perimeter void being in fluid communication with the braking surface of the brake pad, the peripheral wall comprising a first set of one or more openings in fluid communication with the perimeter void for removing brake dust from the braking surface of the brake pad.

The kit may comprise a dust removal means for placing in fluid communication with the first set of one or more openings, and system control means configured to operate the dust removal means so as to remove fluid containing brake dust from the braking surface of the brake pad, e.g. under non-braking conditions and/or under braking conditions.

These aspects of the present invention may comprise any one or more of, or all of, the preferred or optional features discussed herein as appropriate.

According to another aspect of the present invention there is provided a method of modifying a brake system having a brake pad, the method comprising: providing a pressurized fluid supply in fluid communication with the braking surface of the brake pad; and providing a system control means configured to operate the pressurized fluid supply so as to provide fluid to the braking surface of the brake pad under non-braking conditions.

According to another aspect of the present invention there is provided a method of modifying a brake system having a brake pad, the method comprising: providing a fluid removal means in fluid communication with the braking surface of the brake pad; and providing a system control means configured to operate the fluid removal means so as to allow the removal of fluid from the braking surface of the brake pad under braking conditions.

According to another aspect of the present invention there is provided a method of modifying a brake system having a brake pad, the method comprising: providing a dust removal means in fluid communication with the brake pad; and providing a system control means configured to operate the fluid removal means so as to remove fluid containing brake dust from the brake pad, e.g. under non-braking conditions and/or under braking conditions.

According to another aspect of the present invention there is provided a method of modifying a brake pad having a braking surface, the method comprising: providing a peripheral wall about the periphery of the braking surface of the brake pad, wherein a perimeter void is provided between the peripheral wall and at least a portion of the brake pad, the perimeter void being in fluid communication with the braking surface of the brake pad, wherein a first set of one or more openings are provided in fluid communication with the perimeter void for removing brake dust from the braking surface of the brake pad.

The method may comprise providing a dust removal means in fluid communication with the first set of one or more openings, and providing system control means configured to operate the dust removal means so as to remove fluid containing brake dust from the brake pad, e.g. under non-braking conditions and/or under braking conditions.

These aspects of the present invention may comprise the use or provision of any one or more of, or all of, the preferred or optional features discussed herein as appropriate.

### BRIEF DESCRIPTION OF THE DRAWINGS

Preferred embodiments of the present invention will now be described, by way of example only, with reference to the accompanying figures in which:

FIG. 1 is a cross sectional view of a brake system according to an embodiment of the present invention;

FIG. 2 is a brake pad according to an embodiment of the present invention;

FIG. 3A is a brake pad according to another embodiment of the present invention;

FIG. 3B is cross sectional view of the brake pad of FIG. 3A;

FIG. 4 is a combined pressurized fluid supply and fluid suction device arrangement according to one embodiment of the present invention;

FIG. 5 is a cross sectional view of a brake system according to another embodiment of the present invention.

FIGS. 6A-6D are a brake pad assembly according to another embodiment of the present invention.

### DETAILED DESCRIPTION

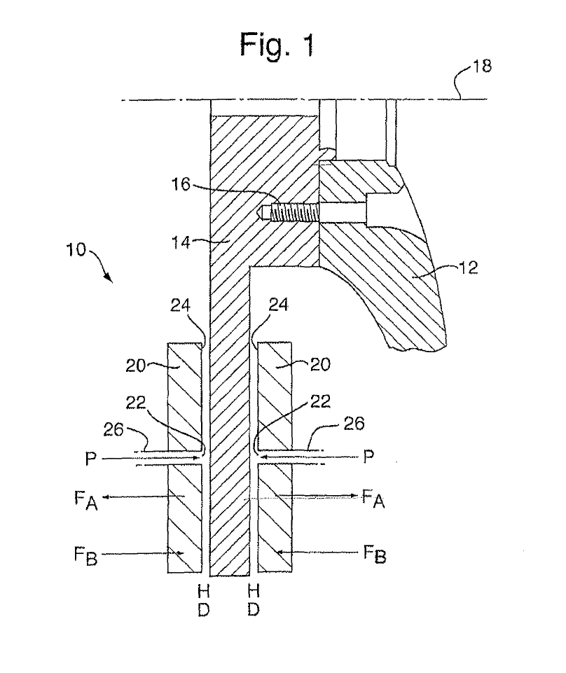

FIG. 1 is a cross sectional view of one embodiment of a brake system 10 for a motor vehicle. The brake system comprises a wheel hub 12 (shown in part) and a brake rotor 14 (brake disc) rotationally fixed to the wheel hub 12 by a fixing 16 such as a bolt. The wheel hub 12 and brake rotor 14 rotate about a centerline 18 when the vehicle is moving.

The brake system 10 further comprises a pair of brake pads 20 adjacent to the brake rotor 14. The brake pads 20 each comprise a friction material on a support structure (not shown). The brake pads 20 each have a braking surface 24 of the friction material that faces the brake rotor 14.

The brake pads are joined to one another by brake calipers (not shown), and the brake calipers are fixed to a static (non-rotating) part of the vehicle. The braking surfaces 24 (and therefore the friction material) of the brake pads 20 can be forced into firm contact with the brake rotor 14 using the brake calipers. The brake calipers are controlled by the brake pedal of the vehicle.

The brake pads 20 each have an opening 22 for providing pressurized fluid (e.g. air) at a pressure P to the braking surface 24 of the brake pad 20 that is adjacent the brake rotor 14. The pressurized fluid is provided to the openings 22 in the braking surface 24 of the brake pad 20 from a compressor or pump (not shown) via tubes 26. The fluid that is provided to the braking surface 24 of the brake pad 20 is allowed to escape from the brake system by venting to the surrounding atmosphere in the gap between the brake pad 20 and the brake rotor 14.

The operation of the compressor or pump is controlled by a system control means (not shown). The system control means may be in communication with a sensor that detects the operation of the brake pedal and/or the accelerator/throttle of the vehicle so to determine whether or not braking conditions exist.

Under non-braking conditions (e.g. when the brake pedal is not activated and/or the accelerator/throttle is activated), the system control means allows pressurized fluid to be provided from the compressor or pump to the braking surfaces 24 of the brake pads 20 via the tubes 26. This may be achieved, for example, by switching the compressor or pump on and/or by opening a supply valve (not shown) that is in fluid communication between the compressor or pump and the braking surface 24.

When the pressurized fluid is provided to the braking surface 24 of the brake pads 20, the fluid pushes the brake pads 20 away from the brake rotor 14 with a force FA. The force FA works against the force FB of the calipers in their non-braking state. As will be appreciated, FA may vary with the distance D that exists between the brake pads 20 and the brake rotor 14. An increase in the distance D between the brake pads 20 and the brake rotor 14 may decrease the force FA. Conversely, a decrease in the distance D between the brake pads 20 and the brake rotor 14 may increase the force FA. The force FB may effectively remain the same, but may vary with the distance D (e.g. an increase in D may lead to an increase in FB and vice versa).

The pressure P of the fluid is selected and provided such that, when FA is equal to FB, the brake pads 20 are positioned and maintained at a suitable distance D away from the brake rotor 14. The distance D need only be enough to prevent the brake pad 20 from contacting the brake rotor 14 (e.g. 10 microns). This prevents or reduces the frictional contact between the brake pad 20 and brake rotor 14, increasing the power and efficiency of the vehicle and decreasing brake pad wear.

Under braking conditions (e.g. when the brake pedal is activated and/or the accelerator/throttle is not (or no longer) activated), the system control means prevents pressurized fluid from being provided to the braking surfaces 24 of the brake pads 20. This may be achieved, for example, by switching the compressor or pump off and/or by closing a valve that is in fluid communication between the compressor or pump and the brake pad braking surface 24 so as to cut-off the fluid supply to the braking surface. This brings the brake pad 20 into contact (or closer contact) with the brake rotor 14, and reduces the braking activation distance and time.

Also under braking conditions, or for a predetermined period of time after a braking operation occurs (e.g. for 1 second), the control system may actively or passively allow fluid to be removed from braking surfaces 24 of the brake pads 20. This may be achieved, for example, by a fluid removal means. For example, the fluid may be removed by switching on a vacuum (not shown) that is in fluid communication with the openings 22 of the brake pads 20, by opening a valve (not shown) in fluid communication with the braking surface 24 that vents to the surrounding atmosphere, or by operating or connecting the aforementioned compressor or pump in reverse. The removal of fluid brings the brake pad 20 into closer contact with the brake rotor 14, and reduces the braking activation distance and time.

In one arrangement, the aforementioned compressor or pump has an input that draws fluid in, and an output that provides pressurized fluid. Under non-braking conditions, the input is fluidly connected to the surrounding atmosphere, and the output is fluidly connected to the openings 22 in the brake pad 20. Under braking conditions, the output is fluidly connected to the surrounding atmosphere, and the input is fluidly connected to the openings 22 in the brake pad 20. Thus, the same compressor or pump can be used both as a pressurized fluid supply and a fluid removal (suction) device.

As will be appreciated the features of the brake system 10 can be retrofitted to an existing brake system. For example, in order to provide the broader embodiments of the brake system 10, openings 20 may be provided (e.g. drilled) though existing brake pads 20 and a tube 26 may be provided in fluid communication with the openings. A suitable compressor or pump may be provided and connected to the tube 26. A suitable system control means may then be provided to control the operation of the brake system 10 in the manner discussed above.

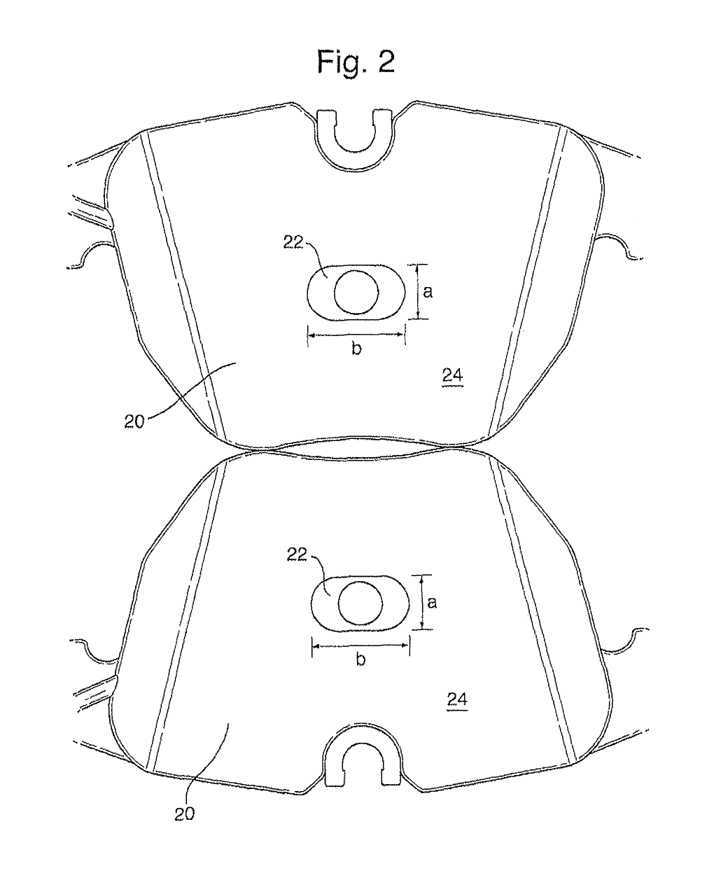

FIG. 2 shows a pair of brake pads 20 according to one embodiment of the present invention. The brake pads 20 each have a braking surface 24 with an opening 22 in that surface. The openings 22 can be fluidly connected with a tube 26 (see FIG. 1). The opening 22 in this particular example is a racetrack slot having a length ‘b’ of 21 mm and a width ‘a’ of 11 mm. Such embodiments are particularly advantageous in that the fluid is centrally, effectively and evenly distributed by the slot to the majority of the surface 24 of the brake pad 20. This can prevent the brake pad 20 from tipping and contacting the adjacent brake rotor 14 when the fluid is supplied to the surface of the brake pad 20.

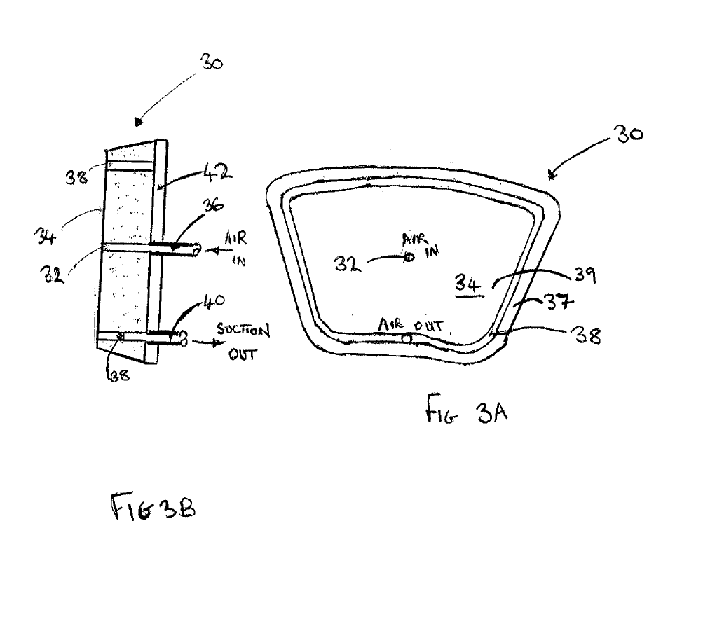

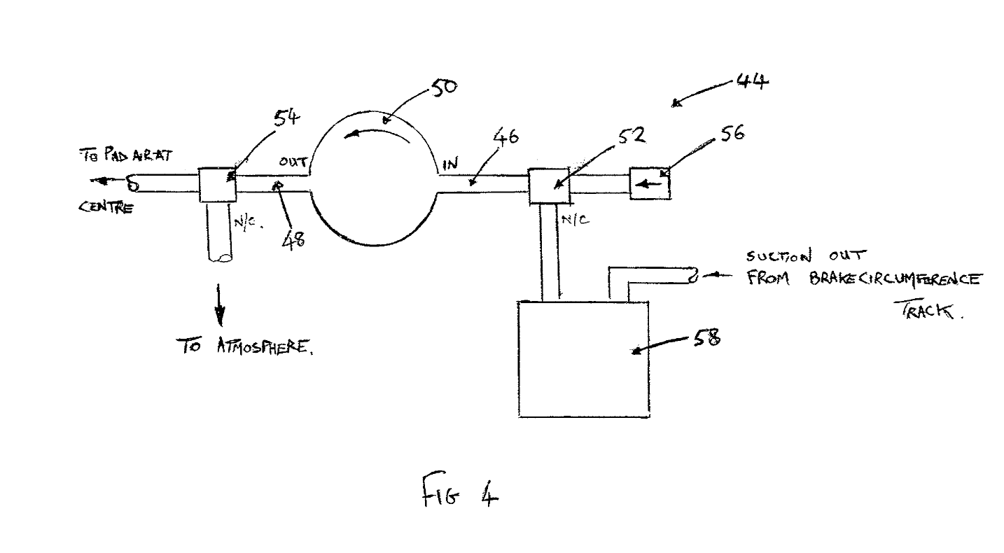

FIGS. 3A and 3B show a brake pad 30 according to another embodiment of the present invention. The brake pad 30 has a braking surface 34 with an opening 32 in that surface. The opening 32 can be fluidly connected with a tube 36 to the pressurized fluid supply. The braking surface also has a circumferential track 38 around the perimeter of the brake pad 30. A peripheral wall 37 is formed by an outer peripheral portion of the brake pad 30, and the circumferential track 38 provides a void between the outer peripheral portion of the brake pad 30 and an inner portion 39 of the brake pad 30. The circumferential track 38 can be fluidly connected with a tube 40 via an opening to a fluid or dust removal means, which in this embodiment also acts as the pressurized fluid supply. FIG. 3B also shows the steel support structure 42 of the brake pad 30.

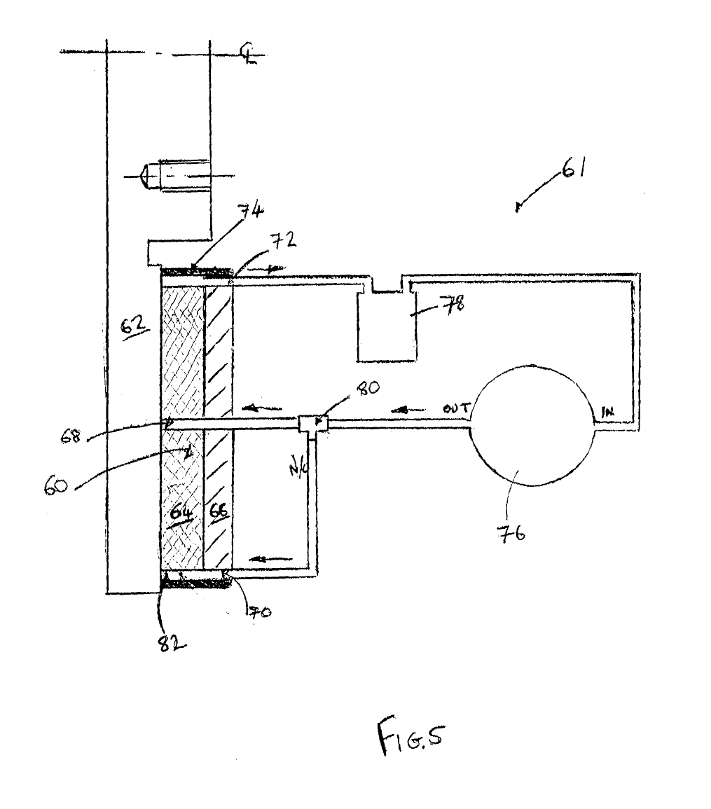

FIG. 4 shows a combined pressurized fluid supply/fluid suction device 44 according to one embodiment of the present invention which may be used in conjunction with the brake pad of FIGS. 3A and 3B. The pressurized fluid supply/fluid suction device 44 comprises a compressor or pump 50 having an input 46 for receiving (filtered/conditioned) fluid and an output 48 for providing pressurized fluid.

When acting as a pressurized fluid supply, the input 46 is placed in fluid communication with the surrounding atmosphere by a first 3-way valve 52 via a first filter/conditioner 56 and the output 48 is placed in fluid communication with the braking surface by a second 3-way valve 54. The first filter/conditioner 56 protects the brake pad 30 and/or compressor or pump 50 by collecting particles and/or removing moisture from the surrounding atmosphere.

When acting as a fluid suction device, the input 46 is placed in fluid communication with the brake pad 30 by the first 3-way valve 52 via a second filter 58 and the output 48 is placed in fluid communication with the surrounding atmosphere by the second 3-way valve 54. The second filter 58 acts to collect braking dust generated under braking.

The first 3-way valve 52 and second 3-way valve 54 in this embodiment are under the control of a system control means.

FIG. 5 is a cross sectional view of a brake system according to another embodiment of the present invention. FIG. 5 shows a brake pad 60 in contact with a brake rotor 62. The brake pad 60 comprises braking material 64 and a support structure 66.

The brake pad 60 comprises a central opening 68 for providing fluid to the braking surface of the brake pad 60, a first perimeter opening 70 for providing fluid to the brake pad 60, and a second perimeter opening 72 for removing fluid and brake dust from the brake pad 60. Fluid is simultaneously provided and removed by a circulating compressor or pump 76. A filter/conditioner 78 is provided between the second perimeter opening 72 and the compressor or pump 76 to collect brake dust generated during braking and/or remove moisture. A diverting valve 80 (a 3-way solenoid valve) is located between the compressor or pump 76 and the centrally located opening 68. The diverting valve 80 is also located between the compressor or pump 76 and first perimeter opening 70.

The diverting valve 80 acts to provide fluid from the compressor or pump 76 to the centrally located opening 68 under non braking conditions so as to separate the brake pad 60 from the brake rotor 62. The diverting valve 80 acts to provide fluid from the compressor or pump 76 to the first perimeter opening 70 under braking conditions to aid the removal of brake dust. The diverting valve 80 in this embodiment is under the control of a system control means.

A peripheral wall is provided by a silicone skirt 74 around the brake pad 60. The skirt 74 translates with brake pad 60 under braking conditions so as to span the gap between the brake pad 60 and the brake rotor 62 under braking conditions, thereby preventing brake dust from the braking surface of the brake pad 60 from entering the surrounding atmosphere under braking conditions. In doing this, the skirt 74 also creates a perimeter void 82 for directing fluid which is provided by the first perimeter opening 70 around the outer periphery of the brake pad 60. The fluid entrains brake dust before being removed by the second perimeter opening 72.

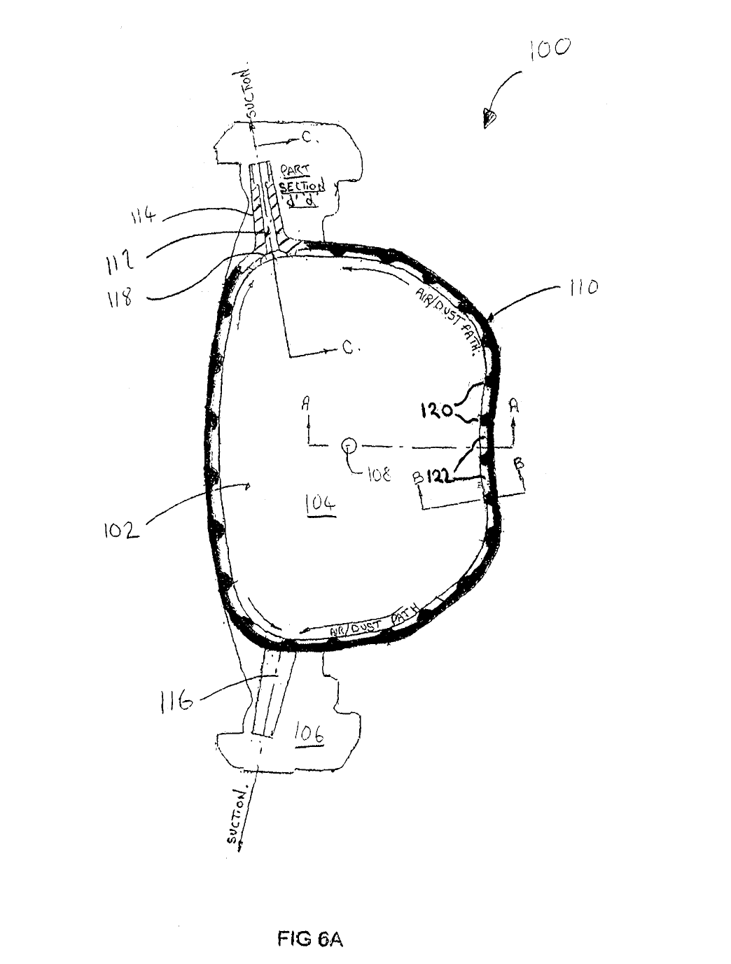

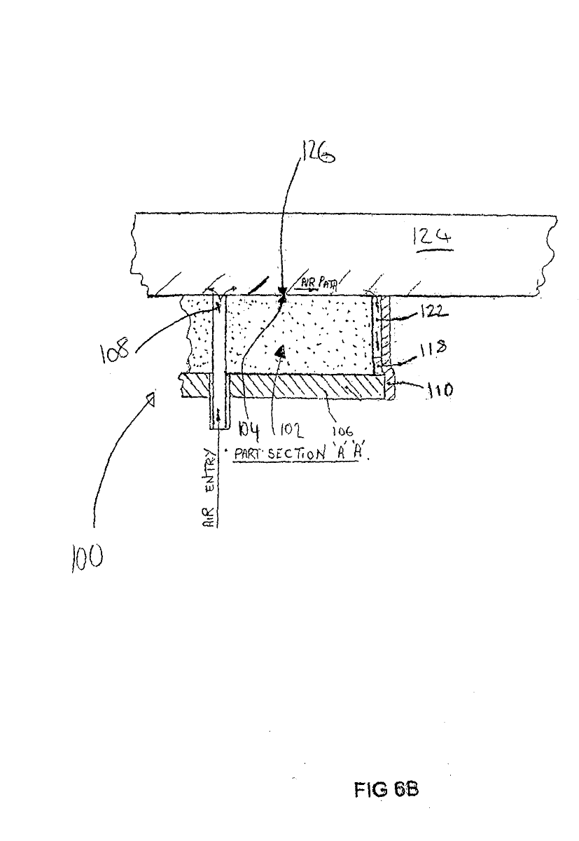

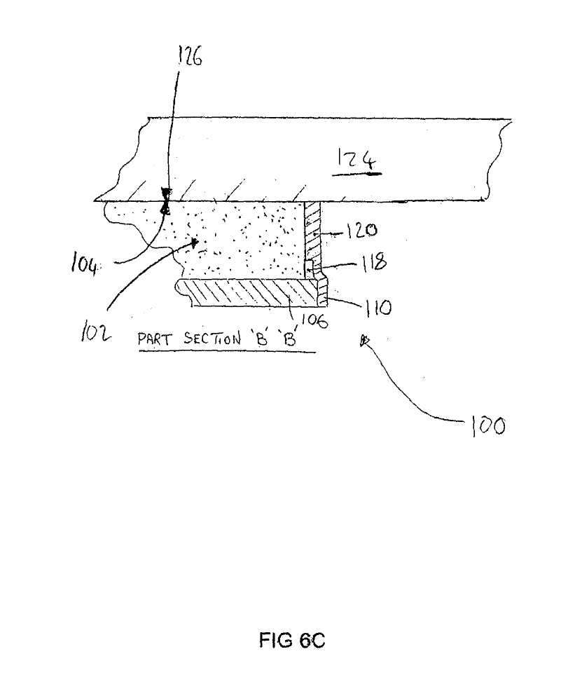

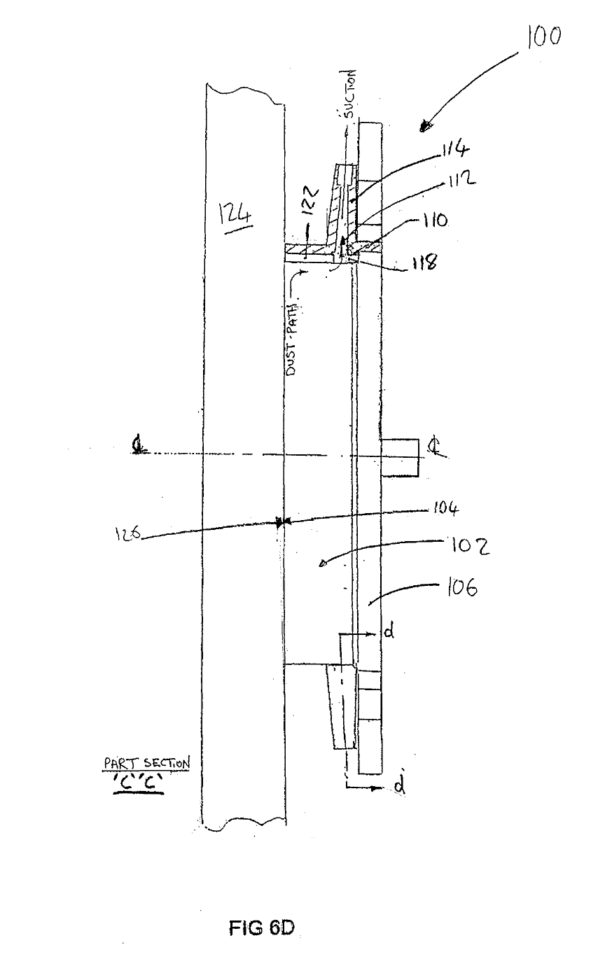

FIGS. 6A-6B show a brake pad assembly 100 according to another embodiment of the present invention.

FIG. 6A is a plan view of the brake pad assembly 100. The brake pad assembly 100 comprises a brake pad 102, and a support structure 106 of the brake pad 102. The brake pad 102 comprises an upper braking surface 104 made of braking material. The brake pad 102 is provided with a central opening 108 in the center of the braking surface 104 for providing fluid to the surface of the brake pad 102 in the manner discussed above.

In this embodiment, the brake pad assembly 100 comprises a peripheral wall provided by a flexible/resilient silicone skirt 110 which extends around the perimeter of the brake pad 102. The skirt 110 comprises partitions 120 which space the skirt 110 from the vertical sides of the brake pad 102 and which provide channels 122 down the sides of the brake pad 102.

The skirt 110 also forms a perimeter void 118 between the brake pad 102 and the skirt 110. Although only part of the perimeter void 118 is shown in the part section though line d-d (as shown in FIG. 6D), it will be appreciated that the perimeter void 118 extends around the periphery of the brake pad 102 between the skirt 110 and the brake pad 102, i.e. below the channels 122. The channels 122 are in fluid communication with both the braking surface 104 of the brake pad 102 and the perimeter void 118. This arrangement allows fluid (e.g. air) containing brake dust from the upper braking surface 104 to flow down through the channels 122 and into the perimeter void 118. The fluid containing brake dust can then circulate around the periphery of the brake pad 102 in the perimeter void 118.

(In some embodiments which are not illustrated, the skirt may provide a further (inner) peripheral wall which may, for example, be bonded to the sides of the brake pad 102. In these embodiments, the void may be provided between the peripheral wall and the further (inner) peripheral wall. In these embodiments, the partitions may be between the peripheral wall and the further (inner) peripheral wall, with the partitions providing channels to the void.)

The skirt 110 further comprises a first opening 112 to a first spigot 114. The first opening 112 allows the removal of the fluid containing brake dust from the perimeter void 118. The skirt 110 also comprises a second opening (not shown) to a second spigot 116. In some embodiments and/or circumstances, the second opening also allows the removal of fluid containing brake dust from the perimeter void 118. However, in other embodiments and/or under other circumstances (as will be discussed below), the second opening may be used to provide fluid to the perimeter void 118 so as to help circulate the fluid containing brake dust around to the first opening 112.

FIG. 6B is a part section through line A-A of FIG. 6A. FIG. 6B shows the brake pad assembly 100 adjacent to a brake rotor (e.g. a brake disc) 124. FIG. 6B shows the braking surface 104 of the brake pad 102 in contact with an opposing braking surface 126 of the brake rotor 124. FIG. 6B also shows the perimeter void 118 which is formed between the skirt 110 and the brake pad 102, and shows one of the channels 112 which is formed by adjacent partitions 120 (see FIG. 6A). FIG. 6B also shows the opening 108 in the brake pad 102 for providing fluid to the braking surface 104 of the brake pad 102.

FIG. 6C is a part section through line B-B of FIG. 6A. FIG. 6C again shows the brake pad assembly 100 adjacent to the brake rotor 124, with the braking surface 104 of the brake pad 102 in contact with the opposing braking surface 126 of the brake rotor 124. FIG. 6C also shows the perimeter void 118 which is formed between the skirt 110 and the brake pad 102, and shows one of the partitions 120 which spaces the skirt 110 from the sides of the brake pad 102.

FIG. 6D is a part section through line C-C of FIG. 6A. FIG. 6D again shows the brake pad assembly 100 adjacent to the brake rotor 124, with the braking surface 104 of the brake pad 102 in contact with the opposing braking surface 126 of the brake rotor 124. FIG. 6D also shows the perimeter void 118 which is formed between the skirt 110 and the brake pad 102 and shows the first opening 112 which allows the removal of fluid containing brake dust from the perimeter void 118 via spigot 114.

As will be appreciated, the skirt 110 can readily be fitted to the brake pad 102 by, for example, stretching the skirt 110 and mounting the skirt 110 around the brake pad 102. The skirt 110 could also be retrofitted to a conventional brake pad in a similar manner.

The use of the brake pad assembly 100 of this embodiment will now be described with reference to FIGS. 6A-6D.

Under non-braking conditions, fluid (e.g. air) is provided to the braking surface 104 of the brake pad 102 via the opening 108 in the braking surface 104. Fluid may be provided, for example, using a pressurized fluid supply (e.g. a pump or compressor output). Although not necessary in this embodiment, the fluid may be provided at a pressure and/or flow rate which is sufficient to separate the braking surface 104 of the brake pad 102 from the brake rotor 124 as discussed above in relation to other embodiments.

Fluid containing brake dust is also removed from the perimeter void 118 through the spigot 114 via the opening 112 in the skirt 110. Fluid containing brake dust is also preferably removed from the perimeter void 118 through the opening in the spigot 116. Fluid may be removed, for example, using a vacuum (or a or the pump or compressor input).

Thus, under non-braking conditions, fluid passes from the opening 108 in the braking surface 104, across the braking surface 104 where brake dust is collected, down the channels 112 and into the perimeter void 118. The fluid containing the brake dust is then removed from the perimeter void 118 through the spigot 114 (and possibly spigot 116) via the opening 112 in the skirt 110.

Under braking conditions, fluid (e.g. air) may or may not be provided to the opening 108 in the braking surface 104. As discussed above in relation to other embodiments, if fluid is provided to the opening 108 in the braking surface 104, then it is preferably at a pressure and/or flow rate which is insufficient to separate the braking surface 104 of the brake pad 102 from the brake rotor 124.

Fluid containing brake dust is also removed from the perimeter void 118 through the spigot 114 via the opening 112 in the skirt 110. Fluid containing brake dust may also be removed from the perimeter void 118 through the opening in the spigot 116.

Thus, under braking conditions, brake dust which is generated under braking and which migrates across the braking surface 104 can be extracted down the channels 122 and into the perimeter void 118. The fluid containing the brake dust can then be removed from the perimeter void 118 through the spigot 114 (and possibly spigot 116) via the opening 112 in the perimeter wall 110.

Alternatively, in some embodiments, under braking conditions, fluid containing brake dust may be removed through the first spigot 114 via the first opening 112 in the perimeter wall but fluid (e.g. air) may be provided to the perimeter void 118 through the second spigot 116 via the second opening in the skirt 110. Fluid may be provided, for example, using the pressurized fluid supply (e.g. the pump or compressor output). This alternative arrangement can help to provide a flow of fluid through the perimeter void 118 under braking conditions. Although preferred embodiments of the present invention have been described, it will be apparent to the skilled person that various features of those embodiments can be altered, removed or substituted without departing from the scope of the invention as defined by the appended claims.

What is claimed is:

1. A brake pad assembly comprising:
a brake pad having a braking surface;
a peripheral wall provided about a periphery of the braking surface of the brake pad, wherein a perimeter void is provided between the peripheral wall and at least a portion of the brake pad, the perimeter void being in fluid communication with the braking surface of the brake pad; and
a first set of one or more openings in fluid communication with the perimeter void for removing brake dust from the braking surface of the brake pad.

2. The brake pad assembly as claimed in claim 1, wherein the peripheral wall is provided by an outer peripheral portion of the brake pad, the peripheral void being between the outer peripheral portion of the brake pad and an inner portion of the brake pad.

3. The brake pad assembly as claimed in claim 1, wherein the brake pad has one or more side surfaces, the peripheral wall being provided around the one or more side surfaces of the brake pad, the peripheral void being between the peripheral wall and the one or more side surfaces of the brake pad.

4. The brake pad assembly as claimed in claim 1, wherein the peripheral wall is provided by a skirt mounted to the brake pad.

5. The brake pad assembly as claimed in claim 3, wherein the peripheral wall is formed from silicone.

6. The brake pad assembly as claimed in claim 3, further comprising a plurality of partitions, wherein:
the plurality of partitions space the peripheral wall from the one or more side surfaces of the brake pad; or
the plurality of partitions provide channels located between the peripheral wall and the one or more side surfaces of the brake pad, the channels being in fluid communication between the perimeter void and the braking surface of the brake pad.

7. The brake pad assembly as claimed in claim 6, wherein:
the plurality of partitions are at least partially rectilinear in cross-section; or
the plurality of partitions are at least partially curved in cross-section.

8. The brake pad assembly as claimed in claim 6, wherein the plurality of partitions are integrally formed with the peripheral wall.

9. The brake pad assembly as claimed in claim 1, wherein the first set of one or more openings are provided through the peripheral wall.

10. The brake pad assembly as claimed in claim 1, further comprising a first set of one or more passages for removing brake dust from the braking surface of the brake pad, the first set of one or more passages being in fluid communication with the perimeter void via the first set of one or more openings.

11. The brake pad assembly as claimed in claim 1, wherein the first set of one or more openings comprises a first opening and a second opening, the first opening being at an opposite side of the brake pad to the second opening.

12. The brake pad assembly as claimed in claim 1, further comprising a second set of one or more openings for providing fluid to the braking surface of the brake pad, the second set of one or more openings being provided in the braking surface of the brake pad, and wherein the second set of one or more openings comprise one or more openings located substantially in a center of the braking surface of the brake pad.

13. (canceled)

14. The brake pad assembly as claimed in claim 12, further comprising a second set of one or more passages for providing fluid to the braking surface of the brake pad, the second set of one or more passages being in fluid communication with the braking surface of the brake pad via the second set of one or more openings.

15. The brake pad assembly as claimed in claim 1, further comprising a set of one or more openings for providing fluid to the perimeter void, and wherein the set of one or more openings for providing fluid to the perimeter void are provided through the peripheral wall.

16. (canceled)

17. The brake pad assembly as claimed in claim 14, further comprising a set of one or more passages for providing fluid to the perimeter void, the set of one or more passages for providing fluid to the perimeter void being in fluid communication with the perimeter void via the set of one or more openings for providing fluid to the perimeter void.

18. The brake pad assembly as claimed in claim 1, further comprising a brake caliper, wherein the brake pad and the peripheral wall are mounted in the brake caliper.

19. A brake system comprising:
a brake pad assembly comprising:
a brake pad having a braking surface;
a peripheral wall provided about a periphery of the braking surface of the brake pad, wherein a perimeter void is provided between the peripheral wall and at least a portion of the brake pad, the perimeter void being in fluid communication with the braking surface of the brake pad; and
a first set of one or more openings in fluid communication with the perimeter void for removing brake dust from the braking surface of the brake pad; and
a brake dust removal means in fluid communication with the first set of one or more openings, wherein the brake dust removal means is configured to remove fluid containing brake dust from the braking surface via the first set of one or more openings.

20. The brake system as claimed in claim 19, further comprising a pressurised fluid supply having an output for providing pressurised fluid to the braking surface or the perimeter void, wherein the pressurised fluid supply is configured to provide pressurised fluid to the braking surface of the brake pad under non-braking conditions.

21. (canceled)

22. The brake system as claimed in claim 20, wherein the pressurised fluid supply is configured to supply fluid at a pressure or a flow rate that is sufficient to separate the braking surface of the brake pad from a braking surface of an opposing brake rotor under non-braking conditions or that is insufficient to separate the braking surface of the brake pad from a braking surface of an opposing brake rotor under braking conditions.

23. The brake system as claimed in claim 20, wherein the pressurised fluid supply is configured to provide pressurised fluid to the perimeter void under non-braking conditions or under braking conditions.

24. The brake system as claimed in claim 19, further comprising fluid conditioning means for warming or drying fluid to be provided to the braking surface or the perimeter void.

25. The brake system as claimed in claim 19, wherein the brake dust removal means comprises a dust filter or a dust collector in fluid communication with the perimeter void for collecting brake dust from fluid which is removed from the brake pad.

26. The brake system as claimed in claim 19, wherein the brake dust removal means comprises a fluid suction device for motivating fluid containing dust and wherein the fluid suction device comprises a vacuum or the pressurised fluid supply operated in reverse or connected in reverse.

27-106. (canceled)
